(19) United States
(12) Patent Application Publication
(10) Pub. No.: US 2020/0161915 A1
(43) Pub. Date: May 21, 2020

(54) STATOR

(71) Applicant: HONDA MOTOR CO., LTD., Tokyo (JP)

(72) Inventors: Ryotaro Kaneko, Wako-shi (JP); Tadao Nishiyama, Wako-shi (JP); Keisuke Azusawa, Wako-shi (JP)

(21) Appl. No.: 16/680,544

(22) Filed: Nov. 12, 2019

(30) Foreign Application Priority Data
Nov. 15, 2018 (JP) 2018-214759

(51) Int. Cl. H02K 3/24; H02K 1/16; H02K 3/14; H02K 3/34

(52) U.S. Cl. CPC H02K 3/24; H02K 3/34; H02K 3/14; H02K 1/16

(57) ABSTRACT

A stator includes an annular stator core, and a coil formed of a plurality of electric wires having a conductor and an insulating film covering the conductor, and having a conductor exposed portion which protrudes in an axial direction of the stator core and in which the conductor is exposed at an end portion of each of the electric wires, and a coupling portion in which a distal end of the conductor exposed portion in one electric wire and a distal end of the conductor exposed portion in another electric wire are coupled. The conductor exposed portion of the electric wire is formed as a curved portion that is curved as a whole.

### CROSS-REFERENCE TO RELATED APPLICATION

Priority is claimed on Japanese Patent Application No. 2018-214759, filed Nov. 15, 2018, the content of which is incorporated herein by reference.

### BACKGROUND OF THE INVENTION

### Field of the Invention

The present invention relates to a stator.

### Description of Related Art

Conventionally, as a stator for a rotary electric machine, there is one that includes a coil that is formed so as to be mounted in a stator core by inserting conductor segments into slots formed in the stator core and coupling conductor end portions protruding from the stator core toward each other. In this type of coil, various technologies for inhibiting an increase in the temperature of the coil end protruding from the stator core have been proposed.

For example, Japanese Unexamined Patent Application, First Publication No. 2003-143810 (hereinafter referred to as Patent Document 1) discloses a structure of a motor which includes a stator having coil ends at both end portions in an axial direction of the stator core and a case having a refrigerant supply port and a refrigerant discharge port. In the technology described in Patent Document 1, the coil includes a conductor exposed portion in which an insulating film is peeled off so that end portions of the coil are coupled at both end portions in the axial direction of the stator core.

In order to cool the conductor exposed portion, a refrigerant is supplied from the refrigerant supply port of the case to the coil end, and then the refrigerant is discharged from the refrigerant discharge port. Thereby, sufficient cooling performance can be secured by inhibiting an increase in the temperature at the coil end.

### SUMMARY OF THE INVENTION

In the technology described in Patent Document 1, since the coil is coupled by peeling off the insulating film of the coil at the coil end, the coil is affected by heat due to welding at the time of coupling. Therefore, in the technology described in Patent Document 1, the length of the conductor exposed portion needs to be increased to inhibit thermal deterioration in the insulating film. However, when the distance between the coupling portion and the insulating film is increased, the coil end is enlarged in the axial direction, and thus there is a likelihood that the motor may be increased in size. Therefore, in the conventional technology, there is room for improvement in terms of providing a stator that can be reduced in size and weight by reducing the distance between the coupling portion and the insulating film in the coil end.

An aspect of the present invention has been made in consideration of such circumstances, and it is one objective of the present invention to provide a stator that can be reduced in size and weight by reducing the distance between the coupling portion and the insulating film in the coil end.

In order to provide a solution to the above-described problem and achieve the objective, the present invention employs the following aspects.

(1) A stator according to an aspect of the present invention includes an annular stator core, and a coil formed of a plurality of electric wires having a conductor and an insulating film covering the conductor and including a conductor exposed portion which protrudes in an axial direction of the stator core and in which the conductor is exposed at an end portion of each of the electric wires, and a coupling portion in which a distal end of the conductor exposed portion in one electric wire and a distal end of the conductor exposed portion in another electric wire are coupled, in which the conductor exposed portion of the electric wire is formed as a curved portion that is curved as a whole.

(2) In the above-described aspect (1), the curved portion may be curved to be convex toward a side of another electric wire to be coupled when viewed from a radial direction of the stator core.

(3) In the above-described aspect (1) or (2), the insulating film may include a hole inside, and the hole may be formed by a hollowed capsule.

(4) In any one of the above-described aspects (1) to (3), the insulating film may include a hole inside, and the hole may be formed of a thermally decomposable resin.

(5) In any one of the above-described aspects (1) to (4), the conductor exposed portion may be formed to have a length of 6 mm or more and 7 mm or less.

According to the above-described aspect (1), the coil has the conductor exposed portion in which the insulating film is peeled off in the coil end protruding in the axial direction of the stator core. When end portions of the electric wires are coupled at the coupling portion of the conductor exposed portion, the coil can be mounted on the stator core.

At this time, since the electric wires have the curved portion in which the conductor exposed portion is curved as a whole, an area in which the end portions of the electric wires overlap can be increased compared to a case in which the conductor exposed portion has a linear portion and is coupled to that of another electric wire by the linear portions intersecting. Also, since the linear portion is not provided, the length in the axial direction of the conductor exposed portion can be reduced. Thereby, an increase in size of the stator in the axial direction can be minimized, and the end portions can be reliably welded and fixed at the time of welding the end portions of the electric wires.

Further, since a degree of freedom in positioning in a height direction (the axial direction of the stator) at the time of welding is improved by increasing the area in which the end portions of the electric wires overlap, workability at the time of manufacturing can be improved.

Therefore, a stator that can be reduced in size and weight can be provided by reducing a distance between the coupling portion and the insulating film in the coil end.

According to the above-described aspect (2), in a pair of electric wires, portions protruding toward a side of another electric wire to be coupled are coupled to each other. Thereby, a range of the coupling portion is expanded, and the coupling work can be easily performed. Therefore, the stator can be configured to have electric wires in which a shorter length for the conductor exposed portion and improvement in workability are achieved at the same time.

According to the above-described aspect (3), since the insulating film has a hole inside and the hole is formed by the hollowed capsule, heat resistance of the entire insulating film can be improved due to presence of an air layer inside the insulating film.

Here, in a conventional technology in which an insulating film having no hole inside is used, when a distance between the coupling portion and the insulating film is small, there is a likelihood that thermal deterioration such as burnt deposits or blistering may occur on the insulating film due to heat of welding of the coupling portion. Therefore, in the conventional technology, in order to inhibit thermal deterioration, a long conductor exposed portion needs to be formed to increase the distance between the coupling portion and the insulating film, and thereby there is a fear that a stator may be increased in size in the axial direction.

According to the above-described aspect (3), heat resistance of the entire insulating film is improved due to the holes provided inside the insulating film, and thereby thermal deterioration of the insulating film due to heat of welding can be inhibited even when the distance between the coupling portion and the insulating film is made small. Therefore, the length of the coil end in the axial direction can be reduced by reducing the length of the conductor exposed portion.

Accordingly, a stator that can be reduced in size and weight can be provided by reducing the distance between the coupling portion and the insulating film in the coil end.

According to the above-described aspect (4), since the hole is formed of a thermally decomposable resin, the hole can be formed inside the insulating film by heating the insulating film to a predetermined temperature after the electric wire is manufactured. In this manner, since the hole can be formed inside the insulating film with a simple method, workability can be improved.

According to the above aspect (5), since the conductor exposed portion is preferably formed to have a length of 6 mm or more and 7 mm or less, thermal deterioration of the insulating film due to heat at the time of welding can be inhibited while the length of the coil end in the axial direction is reduced. Therefore, the stator can achieve both reduction in size and inhibition of thermal deterioration.

### BRIEF DESCRIPTION OF THE DRAWINGS

FIG. 1 is an external perspective view of a stator according to an embodiment.

FIG. 2 is an enlarged view of a coil end according to the embodiment.

FIG. 3A is a cross-sectional view of a conductor at a height position IIIa-IIIa in FIG. 2.

FIG. 3B is a cross-sectional view of the conductor at a height position IIIb-IIIb in FIG. 2.

FIG. 3C is a cross-sectional view of the conductor at a height position IIIc-IIIc in FIG. 2.

FIG. 4 is a cross-sectional view of an electric wire according to the embodiment.

FIG. 5 is a graph showing a relationship between a length of a conductor exposed portion and a temperature of a base end portion of the conductor exposed portion at the time of welding.

FIG. 6 is an enlarged view of a coil end according to a comparative example.

FIG. 7A is a cross-sectional view of a conductor at a height position VIIa-VIIa in FIG. 6.

FIG. 7B is a cross-sectional view of the conductor at a height position VIIb-VIIb in FIG. 6.

FIG. 7C is a cross-sectional view of the conductor at a height position VIIc-VIIc in FIG. 6.

### DETAILED DESCRIPTION OF THE INVENTION

Embodiments of the present invention will be described below with reference to the drawings.

(Stator)

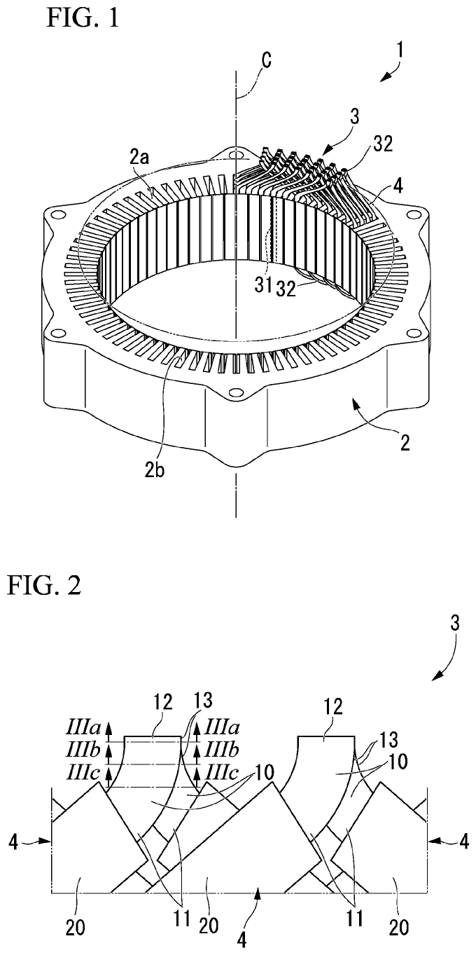

FIG. 1 is an external perspective view of a stator 1.

The stator 1 includes a stator core 2 and a coil 3. In FIG. 1, a portion of the coil 3 is omitted for explanation.

The stator core 2 is formed in an annular shape with an axis C as a center. Teeth 2a are formed on an inner circumferential surface of the stator core 2. The teeth 2a protrude inward in a radial direction from the inner circumferential surface of the stator core 2. A plurality of teeth 2a are provided in a circumferential direction.

A space between each of the teeth 2a is a slot 2b, and a coil 3 to be described below is inserted into each slot 2b. Inside the stator core 2, a rotor (not illustrated) is disposed to be rotatable around the axis C.

In the following description, a direction along the axis C of the stator core 2 is referred to as an axial direction, a direction perpendicular to the axis C is referred to as a radial direction, and a direction around the axis C is referred to as a circumferential direction in some cases.

The coil 3 is wound around the teeth 2a of the stator core 2 and inserted into the slot 2b. The coil 3 is formed of a plurality of electric wires 4. Specifically, the coil 3 is formed by causing end portions of the electric wires 4 to face one side in the axial direction in a state in which the plurality of electric wires 4 bent in a U-shape are overlapped in the circumferential direction and inserting the electric wires 4 into the slot 2b from the other side in the axial direction. After the electric wires 4 are inserted into the stator core 2, the end portions of the electric wires 4 protruding toward one side in the axial direction are twisted and bent so that the end portions are coupled to each other, and thereby the coil 3 is fixed to the stator core 2. In the coil 3, a portion inserted into the slot 2b is referred to as a coil insertion part 31, and a portion protruding from an end surface of the stator core 2 toward one side and the other side in the axial direction is referred to as a coil end 32.

FIG. 2 is an enlarged view of the end portion of the electric wire 4 in the coil end 32 positioned on one side in the axial direction. Also, FIG. 4 is a cross-sectional view of the electric wire 4.

The electric wire 4 includes a conductor 10 and an insulating film 20.

The conductor 10 constitutes a core portion of the electric wire 4 and is formed in a linear shape having a rectangular cross section.

The conductor 10 includes a conductor exposed portion 11 at a distal end portion of the coil end 32 protruding toward the other side in the axial direction.

As illustrated in FIG. 2, the conductor exposed portion 11 is a portion at which the conductor 10 is exposed at the end portion of the electric wire 4. The conductor exposed portions 11 adjacent to each other in the plurality of electric wires 4 are electrically and mechanically joined to each other by welding. Of the adjacent electric wires 4, a portion at which a distal end of the conductor exposed portion 11 in one electric wire 4 and a distal end of the conductor exposed portion 11 in another electric wire 4 are coupled is referred to as a coupling portion 12. The coupling portion 12 is coupled by, for example, TIG welding. The conductor exposed portion 11 of one electric wire 4 is formed as a curved portion 13 that is curved as a whole to be convex toward another electric wire 4 when viewed from the radial direction of the stator core 2. In other words, the conductor exposed portion 11 has only the curved portion 13. A curvature of the curved portion 13 gradually reduces from a base end portion toward a distal end portion of the conductor exposed portion 11. Further, the base end portion of the conductor exposed portion 11 is a portion of the conductor exposed portion 11 positioned at a boundary portion between the conductor exposed portion 11 and the insulating film 20. The conductor exposed portion 11 is formed to have a length of 6 mm or more and 7 mm or less.

Here, a method of setting the length of the conductor exposed portion 11 will be described.

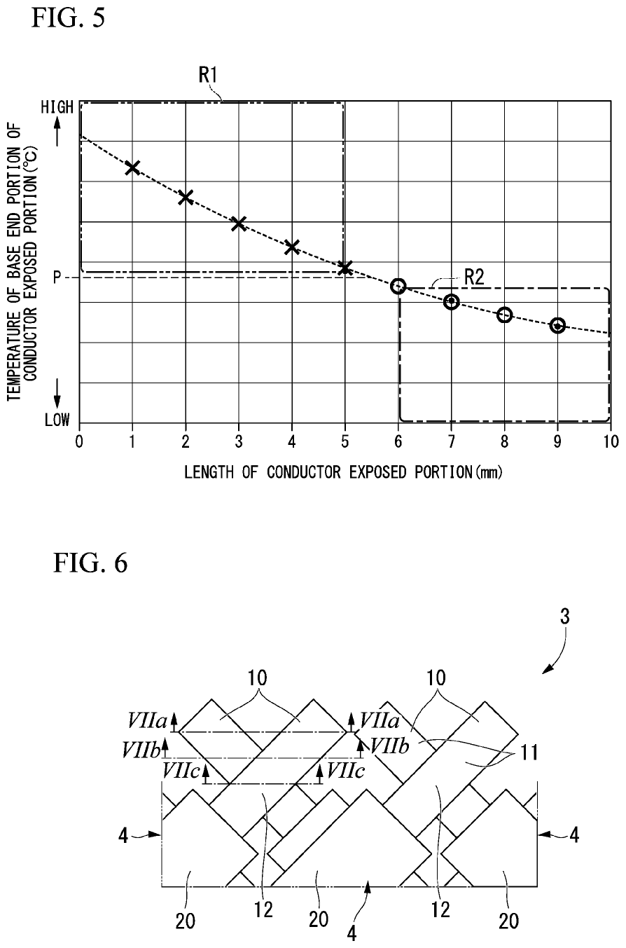

FIG. 5 is a graph showing a relationship between a length of the conductor exposed portion 11 and a temperature of the base end portion of the conductor exposed portion 11 at the time of welding when the horizontal axis represents a length of the conductor exposed portion 11 and the vertical axis represents a temperature of the base end portion of the conductor exposed portion 11 at the time of welding.

When the temperature of the base end portion of the conductor exposed portion 11 exceeds a predetermined temperature P, the insulating film 20 is affected by heat, and thermal deterioration such as burnt deposit or blistering occurs. Here, the predetermined temperature P may be, for example, a heat resistant temperature of the insulating film 20.

As illustrated in FIG. 5, when the length of the conductor exposed portion 11 is 5 mm or less (a region R1), since a distance between the coupling portion 12 and the insulating film 20 is small, the temperature of the base end portion is higher than the predetermined temperature P and thermal deterioration occurs. On the other hand, when the length of the conductor exposed portion 11 is 6 mm or more (a region R2), since the distance between the coupling portion 12 and the insulating film 20 is large, the temperature of the base end portion is lower than the predetermined temperature P. Therefore, although thermal deterioration does not occur, an axial dimension of the stator 1 increases as the length of the conductor exposed portion 11 becomes larger.

Therefore, the length of the conductor exposed portion 11 needs to be set so that the length of the conductor exposed portion 11 is minimized within a range of the region R2 in which thermal deterioration does not occur. Thereby, the length of the conductor exposed portion 11 of the present embodiment is preferably set to 6 mm or more and 7 mm or less, and more preferably closer to 6 mm.

Returning to FIG. 2, the insulating film 20 covers an outer circumferential portion of the conductor 10. The insulating film 20 is formed of an insulating material such as, for example, a resin. The insulating film 20 is formed over the entire length of the conductor 10 excluding the conductor exposed portion 11. The insulating film 20 includes an insulating material 21 and a capsule 22 (see FIG. 4).

The insulating material 21 is formed of an insulating resin such as, for example, polyimide. The insulating material 21 includes a plurality of hollowed capsules 22 inside.

The capsules 22 are formed of a resin different from that of the insulating material 21. The capsules 22 are a resin such as, for example, silicone. The capsules 22 are formed in a spherical shape. A hole 23 is formed inside each of the capsules 22. In other words, the insulating film 20 includes the hole 23 inside, and the hole 23 is formed by the hollowed capsule 22.

The hole 23 is formed of a thermally decomposable resin (not illustrated). Specifically, the hole 23 is formed inside the insulating material 21 when the thermally decomposable resin contained in the insulating material 21 is heated and the thermally decomposable resin is gasified. Here, an outer shell material (the capsule 22 later) made of silicone is disposed on an outer circumferential portion of the thermally decomposable resin before gasification, the insulating film 20 is heated in this state, and thereby the hollowed capsule 22 is formed.

Further, before the gasification, the outer circumferential portion of the thermally decomposable resin may not be covered with the outer shell material. That is, the capsule 22 may be omitted. In this case, the hole 23 is formed inside the insulating material 21. However, according to the configuration in which the capsule 22 is provided in the present embodiment, since formation of a large cavity due to a plurality of holes 23 combined inside the insulating film 20 can be inhibited, there is an advantage that a high strength can be maintained for the insulating film.

(Operation and Effects)

Next, the operation and effects of the stator 1 will be described.

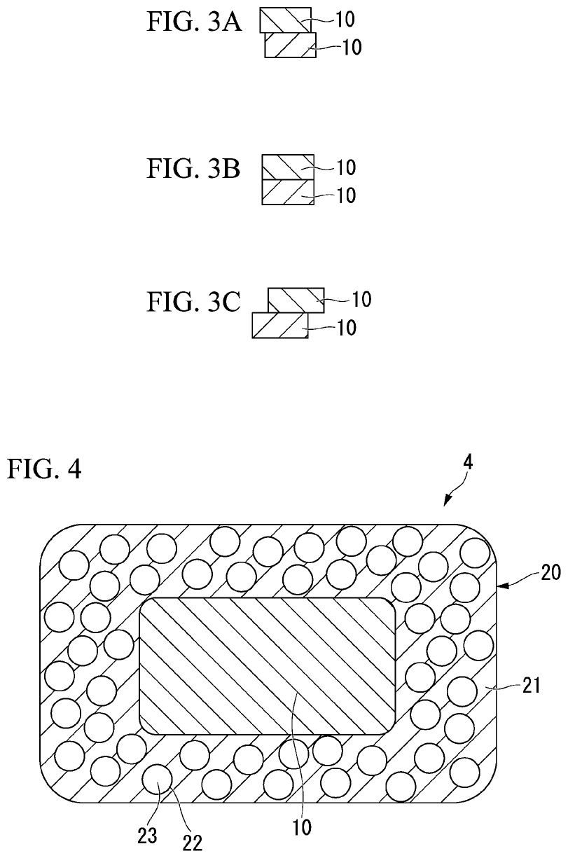

Here, FIGS. 3A, 3B, and 3C are cross-sectional views of the conductor 10 at each of the height positions IIIa-IIIa, IIIb-IIIb, and Inc-Inc in FIG. 2.

As illustrated in FIGS. 3A, 3B, and 3C, since the conductor exposed portion 11 is curved as a whole, the conductor 10 of one electric wire 4 and the conductor 10 of another electric wire 4 overlap in the radial direction at any of the height positions IIIb-IIIb, and IIIc-IIIc. Thereby, an area in which the end portions of the electric wires 4 overlap increases, and thereby a degree of freedom in positioning at the time of welding is improved and the end portions can be reliably coupled.

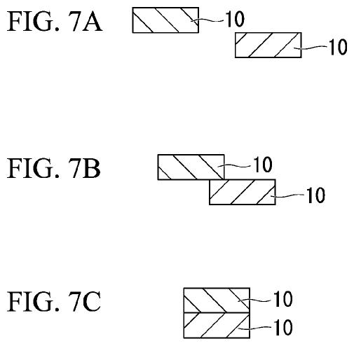

On the other hand, FIG. 6 is an enlarged view of the coil end 32 according to a comparative example, and FIGS. 7A, 7B, and 7C are cross-sectional views of the conductor 10 at each of the height positions VIIa-VIIa, VIIb-VIIb, and VIIc-VIIc in FIG. 6. As illustrated in FIG. 7A, FIG. 7B, and FIG. 7C, when the conductor exposed portion 11 has only a linear portion, a range in which the conductor 10 of one electric wire 4 and the conductor 10 of another electric wire 4 overlap in the radial direction is narrow. Specifically, the conductors 10 overlap in the radial direction only at the height position VIIc-VIIc illustrated in FIG. 7C, and the conductors 10 do not overlap or the overlapping area is reduced at the height positions VIIa-VIIa and VIIb-VIIb illustrated in FIGS. 7A and 7B. Therefore, a portion that can be welded is limited to the narrow range near the height position VIIc-VIIc.

According to the stator 1 of the present configuration, the coil 3 has the conductor exposed portion 11 in which the insulating film 20 is peeled off in the coil end 32 protruding in the axial direction of the stator core 2. When the end portions of the electric wires 4 are coupled at the coupling portion 12 of the conductor exposed portions 11, the coil 3 can be mounted on the stator core 2. At this time, since the electric wires 4 have the curved portion 13 in which the conductor exposed portion 11 is curved as a whole, an area in which the end portions of the electric wires 4 overlap can be increased compared to the case in which the conductor exposed portion 11 has a linear portion and is coupled to that of another electric wire 4 by the linear portions intersecting. Also, since the linear portion is not provided, the length in the axial direction of the conductor exposed portion 11 can be reduced.

Thereby, an increase in size of the stator 1 in the axial direction can be reduced, and the end portions can be reliably welded and fixed at the time of welding the end portions of the electric wires 4.

Further, since a degree of freedom in positioning in a height direction (the axial direction of the stator 1) at the time of welding is improved by increasing the area in which the end portions of the electric wires 4 overlap, workability at the time of manufacturing can be improved.

Therefore, the stator 1 that can be reduced in size and weight can be provided by reducing the distance between the coupling portion 12 and the insulating film 20 in the coil end 32.

Also, in a pair of electric wires, portions protruding toward a side of another electric wire to be coupled are coupled to each other. Thereby, a range of the coupling portion is expanded, and the coupling work can be easily performed. Therefore, the stator can be configured to have electric wires in which a shorter length for the conductor exposed portion and improvement in workability are achieved at the same time.

Since the insulating film 20 has the holes 23 inside and the holes 23 are formed by the hollowed capsules 22, heat resistance of the entire insulating film 20 can be improved due to presence of an air layer inside the insulating film 20.

Here, in a conventional technology in which the insulating film 20 having no holes 23 inside is used, when a distance between the coupling portion 12 and the insulating film 20 is small, there is a likelihood that thermal deterioration such as burnt deposit or blistering may occur on the insulating film 20 due to heat of welding of the coupling portion 12. Therefore, in the conventional technology, in order to inhibit thermal deterioration, a long conductor exposed portion 11 needs to be formed to increase the distance between the coupling portion 12 and the insulating film 20, and thereby there is a likelihood that the stator 1 will be increased in size in the axial direction.

In the stator 1 of the present configuration, since heat resistance of the entire insulating film 20 is improved due to the holes 23 provided inside the insulating film 20 even when the distance between the coupling portion 12 and the insulating film 20 is made small, thermal deterioration of the insulating film 20 due to the heat of welding can be inhibited. Therefore, the length of the coil end 32 in the axial direction can be reduced by reducing the length of the conductor exposed portion 11.

Accordingly, the stator 1 that can be reduced in size and weight can be provided by reducing the distance between the coupling portion 12 and the insulating film 20 in the coil end 32.

Also, since the holes 23 are formed of a thermally decomposable resin, the holes 23 can be formed inside the insulating film 20 by heating the insulating film 20 to a predetermined temperature after the electric wire 4 is manufactured.

In this manner, since the holes 23 can be formed inside the insulating film 20 with a simple method, workability can be improved.

According to the stator 1 of the present configuration, since the conductor exposed portion 11 is formed to have a length of 6 mm or more and 7 mm or less, thermal deterioration of the insulating film 20 due to heat at the time of welding can be inhibited while the length of the coil end 32 in the axial direction is reduced. Therefore, the stator 1 can achieve both reduction in size and inhibition of thermal deterioration.

The technical scope of the present invention is not limited to the above-described embodiments, and various modifications can be made without departing from the spirit of the present invention.

For example, the coupling portion 12 may be provided on both one side and the other side of the stator core 2 in the axial direction.

Also, the cross-sectional shape of the conductor 10 may be other than a rectangular shape such as a circular shape or an elliptical shape.

In addition, the components in the above-described embodiments can be appropriately replaced with well-known components without departing from the spirit of the present invention, and furthermore, the above-described modified examples may be appropriately combined.

What is claimed is:

1. A stator comprising:
an annular stator core; and
a coil formed of a plurality of electric wires having a conductor and an insulating film covering the conductor and including:
a conductor exposed portion which protrudes in an axial direction of the stator core and in which the conductor is exposed at an end portion of each of the electric wires; and
a coupling portion in which a distal end of the conductor exposed portion in one electric wire and a distal end of the conductor exposed portion in another electric wire are coupled, wherein
the conductor exposed portion of the electric wire is formed as a curved portion that is curved as a whole.

2. The stator according to claim 1, wherein the curved portion is curved to be convex toward a side of another electric wire to be coupled when viewed from a radial direction of the stator core.

3. The stator according to claim 1, wherein
the insulating film includes a hole inside, and
the hole is formed by a hollowed capsule.

4. The stator according to claim 1, wherein
the insulating film includes a hole inside, and
the hole is formed of a thermally decomposable resin.

5. The stator according to claim 1, wherein the conductor exposed portion is formed to have a length of 6 mm or more and 7 mm or less.
